(19) United States
(12) Patent Application Publication
(10) Pub. No.: US 2025/0082437 A1
(43) Pub. Date: Mar. 13, 2025

(54) Surgical Protector for Dental Devices

(71) Applicant: Damir MUKHAMADIEV, Moscow (RU)

(72) Inventor: Damir MUKHAMADIEV, Moscow (RU)

(21) Appl. No.: 18/244,375

(22) Filed: Sep. 11, 2023

(51) Int. Cl. A61C 1/16

(52) U.S. Cl. CPC A61C 1/16

(57) ABSTRACT

Any use of a rotating disc in the oral cavity in patients is extremely dangerous. During dental operations, damage to soft tissues, as well as to the fingers of the surgeon, is possible with a rotating disk, so a protective device is required to avoid such damage. The present inventions relate to a cover for a rotating dental disk allowing the safe cutting of bone in the oral cavity. These inventions could consist of a body of two longitudinal strips, two rings, an inner channel, and a thrust pad for disk positioning. Alternatively, the inventions could include a single longitudinal strip. The protector could be made of plastic or photopolymer plastic (ABS similar) and could be produced by SLA photopolymer printing or through press forming.

### CROSS REFERENCE

This patent application is a priority patent application. It is related to Russian Patent RU213284U1, “Safety device for surgical contra-angle dental handpiece”, invented by the inventor, Damir Mukhamadiev, issued on Sep. 5, 2022, said application incorporated herein in its entirety by reference. This application is also related to Russian Patent 209974U1, “Protective Device for Surgical Dental Handpiece”, invented by the inventor, Damir Mukhamadiev, issued on Mar. 24, 2022, said application incorporated herein in its entirety by reference.

### FIELD OF THE INVENTION

The present inventions relate generally to the field of dentistry. More specifically, the present inventions discuss oral surgery, implantology, and maxillofacial surgery.

### BACKGROUND OF THE INVENTIONS

The following discussion outlines a tool and method that can be used to cut bone of the alveolar ridge or harvest bone tissue in the lower jaw or create a window for entering the maxillary sinus or for any kind of osteotomy of any bone tissue.

Dentists performing implant procedures are often faced with the challenge that bone has been lost in the oral cavity as a result of bone atrophy, accidents, periodontitis, or tooth extraction.

When dental implants are planned, it is important that these bone deficits be reconstructed before or at the same time that the implant is placed, so that the dental implants once again have a new foundation and a stable support.

The alveolar process is the part of the jaw bone where the teeth are genetically and where the implants are placed.

One method for increasing the volume of alveolar bone is bone splitting.

In this case, the alveolar process is sawn along with a special rotating disk and then split with a special chisel or other tool. This increases the width of the alveolar bone, which allows the installation of implants.

Another way to increase the volume of lost bone tissue is to add/graft autogenous bone tissue taken from another part of the jaw of the same patient.

Autologous bone is still considered to be the gold standard in bone grafting procedures. This is due to the properties of the bone, since autologous bone combines osteogenic, osteoinductive, and osteoconductive properties.

There are different areas and methods of bone harvesting. In particular, bone tissue can be taken from the external oblique line of the lower jaw or chin. Bone sampling in the lower jaw has advantages in terms of bone tissue quality-homogeneous bone tissue is denser and has elastic mechanical properties. There are various methods and tools for taking bone tissue.

The bone harvesting may in this case take place using various instruments. The concept of bone harvesting is mostly similar here.

Three to four predetermined cut lines are created using either a so-called Lindemann bur or a piezosurgery device, or, alternatively, a small disk, and the block is subsequently extracted using a chisel or another instrument.

The method of harvesting bone with a rotating disc is the fastest and thinnest with cutting lines.

However, any use of a rotating disc in the oral cavity in patients is extremely dangerous and there is a risk of further injury. During dental operations, damage to soft tissues, as well as to the fingers of the surgeon, is possible with a rotating disk, so a protective device is required to avoid such damage.

### SUMMARY OF THE INVENTIONS

In some aspects, the techniques described herein relate to a protective apparatus for a dental device including a large cone-shaped ring with a gap; a first longitudinal strip connected to a first side of the gap; a second longitudinal strip connected to a second side of the gap; a small cone-shaped ring connected to the first longitudinal strip and to the second longitudinal strip; a neck connected to the small cone-shaped ring, the neck including an inner channel; and a thrust platform connected to the neck.

In some aspects, the techniques described herein relate to a protective apparatus where the neck is a half cylinder.

In some aspects, the techniques described herein relate to a protective apparatus where the inner channel extends into the small cone-shaped ring.

In some aspects, the techniques described herein relate to a protective apparatus where the large cone-shaped ring, the first longitudinal strip, the second longitudinal strip, the small cone-shaped ring, the neck, and the thrust platform are plastic.

In some aspects, the techniques described herein relate to a protective apparatus where the plastic is a single piece.

In some aspects, the techniques described herein relate to a protective apparatus where the plastic is printed with a 3D printer.

In some aspects, the techniques described herein relate to a protective apparatus wherein the 3D printer is an SLS photopolymer printer.

In some aspects, the techniques described herein relate to a protected dental surgery system including a protective apparatus including a large cone-shaped ring with a gap; a first longitudinal strip connected to a first side of the gap; a second longitudinal strip connected to a second side of the gap; a small cone-shaped ring connected to the first longitudinal strip and to the second longitudinal strip; a neck connected to the small cone-shaped ring, the neck including an inner channel; and a thrust platform connected to the neck; and a handpiece including a rotary motor; a case surrounding the rotary motor, the case partially inserted within the large cone-shaped ring, the first longitudinal strip, the second longitudinal strip, and the small cone-shaped ring; a shaft connected to one end of the rotary motor and the case, the shaft inside of the neck; and a disk connected to the shaft, the disk above the thrust platform.

In some aspects, the techniques described herein relate to a protected dental surgery system where the disk is a saw.

In some aspects, the techniques described herein relate to a protected dental surgery system where the thrust platform includes a raised half cylinder extending above the neck.

In some aspects, the techniques described herein relate to a protected dental surgery system where the disk is on a plane above the thrust platform and below a top of the raised half cylinder.

In some aspects, the techniques described herein relate to a protected dental surgery system where the handpiece further includes an irrigation tube connected to the case and located in the inner channel.

In some aspects, the techniques described herein relate to a protected dental surgery system where the inner channel extends into the small cone-shaped ring and the irrigation tube continues through the inner channel in the small cone-shaped ring.

In some aspects, the techniques described herein relate to a protected dental surgery system where the protective apparatus is made of injection molded plastic.

In some aspects, the techniques described herein relate to a protected dental surgery system that further comprises an angular handpiece protector including a cylinder segment housing wall; a small ring and a large ring, which are spaced apart and connected by a base wall, the small ring connected to the cylinder segment housing wall; and an end semi-ring with a thrust pad connected to the cylinder segment housing wall.

In some aspects, the techniques described herein relate to a method of using a protected dental surgery system including: removing a shaft and a disk from a handpiece, the handpiece including a rotary motor, a case surrounding the rotary motor, the shaft connected to one end of the rotary motor and the case, the disk connected to the shaft, and an irrigation tube; removing the irrigation tube from the handpiece; inserting the irrigation tube in a channel in a protective apparatus, the protective apparatus including a large cone-shaped ring with a gap, a first longitudinal strip connected to a first side of the gap, a second longitudinal strip connected to a second side of the gap, a small cone-shaped ring connected to the first longitudinal strip and to the second longitudinal strip, a neck connected to the small cone-shaped ring, the neck including an inner channel, and a thrust platform connected to the neck; inserting the handpiece in the protective apparatus by sliding the one end through the large cone-shaped ring and into the small cone-shaped ring; reconnect the irrigation tube to the handpiece; and inserting the shaft and the disk through the thrust platform and into the one end of the rotary motor and the case.

In some aspects, the techniques described herein relate to a method that further includes placing the handpiece and the protective apparatus in a mouth.

In some aspects, the techniques described herein relate to a method that further includes rotating the disk using the rotary motor of the handpiece.

In some aspects, the techniques described herein relate to a method that further includes cutting bone in the mouth with the rotating disk.

In some aspects, the techniques described herein relate to a method wherein the disk is a diamond disk.

In some aspects, the techniques described herein relate to a method that further includes disposing of the protective apparatus after each use.

### BRIEF DESCRIPTION OF THE DRAWINGS

FIG. 1 is a perspective view of the protector device for a straight handpiece.

FIG. 2 is a side view of the protector device for a straight handpiece.

FIG. 3 is a different side view of the protector device for a straight handpiece.

FIG. 4 is an end view of the protector device for a straight handpiece.

FIG. 5 is a photograph of the protector device on a straight surgical handpiece.

FIG. 6 is a photograph of the protector device in use during oral surgery.

FIG. 7 is a perspective view of the protector device for an angular handpiece.

FIG. 8 is a photograph of the protector device on an angular surgical handpiece.

### DETAIL DESCRIPTIONS OF THE INVENTIONS

Note that the specific embodiments given in the drawings and the following description do not limit the disclosure. On the contrary, they provide the foundation for one of ordinary skill to discern the alternative forms, equivalents, and modifications that are contemplated by the inventors and encompassed in the claim scope.

The aim of the protector apparatus 100,700 is to protect the soft tissues and the operator's hands from damage. There is a need in the dental industry to prevent unintended cutting of tissue when using surgical handpieces 501,801.

The purpose is to provide an inexpensive and user-friendly disposable protective device 100,700 for dental operations. The items disclosed below could be incorporated into a system with the protective device 100 incorporated with the handpiece 501 and perhaps also including the angular handpiece 801 and the angular handpiece protector 700.

### Straight Handpiece Protector 100.

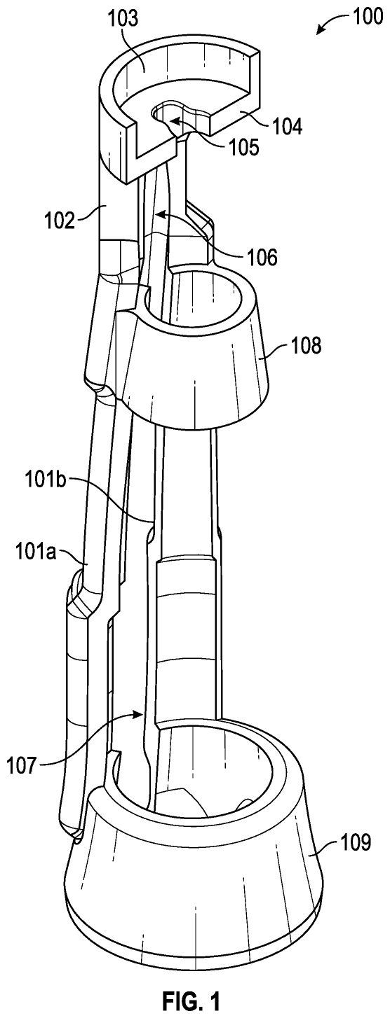

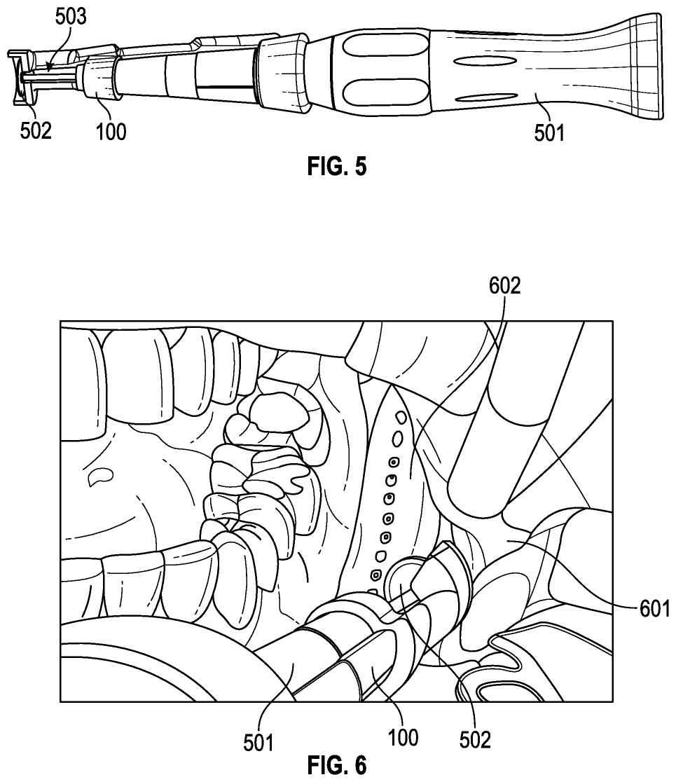

The technical result could be achieved by a protective device 100 that could be made of plastic (or photopolymer (ABS similar)) for a surgical dental handpiece 501, as seen in FIG. 1. The dental handpiece 501 could include a disk 502, the disk 502 connected to the handpiece 501 through a shaft 503, as seen in FIG. 5. The protector 100 may contain a body of two longitudinal strips 101a, 101b passing a cone-shaped small fixing ring 108 into a neck 102 made in the form of an elongated half cylinder with an end half-ring located at its end 103 with a thrust platform 104 for placement of the disk 502 in it, in the center of the thrust pad there could be a recess for the location of the shaft 503. The thrust platform 104 could have a raised half cylinder opposite the neck 102. The thrust platform 104 could have a cutout for allowing the shaft 503 to extent into the thrust platform 104. On the inner surface of the neck in the center there could be a channel 106 for the location of the irrigation tube of the handpiece 501. The channel 106 could extend through the thrust platform 104. The channel 106 could extend into the cone-shaped small fixing ring 108. The longitudinal strips 101a, 101b may be spaced apart to form an opening 107, and in the opposite part of the body on the longitudinal strips, small fixing ring 108 and large fixing ring 109 could be located coaxially and at a distance from each other for fixing a surgical dental handpiece 501 in them, and autorotational grooves 401 could be made on the large fixing ring 109 for putting on a dental handpiece 501. Large ring 109 could have a gap 301, which allows some expansion of protector 100 during installation on handpiece 501.

The protector 100 may contain a body of more than two longitudinal strips 101a, 101b in some embodiments. In still another embodiment, the protector 100 may only have a single longitudinal strip 101a or 101b, with the cone-shaped small fixing ring 108 and the cone-shaped large fixing ring 109 connected on one side with the single longitudinal strip 101a or 101b. The length of the longitudinal strip 101a, 101b may be determined by the length of the surgical dental handpiece 501, as seen in FIG. 5. In some embodiments, the shape of the longitudinal strip 101a, 101b is designed to conform to the shape of the handpiece 501. FIGS. 1, 2, and 3 show a shape of the longitudinal strip 101a, 101b that steps inward to confirm to the narrowing neck of the handpiece 501.

Similarly, the size of the cone-shaped small fixing ring 108 and the cone-shaped large fixing ring 109 could be determined by the diameter of the surgical dental handpiece 501.

The length of the neck 102 of the protector 100 may be determined by the length of the shaft 503 of the handpiece 501. In some embodiments, the handpiece 501 allows for the adjustment of the length of the shaft 503 beyond the top of the handpiece 501. In some embodiments, the shaft 503 may be adjusted such that the disk 502 is in the middle of the raised half cylinder on the top of the thrust platform 104.

The shape of the thrust platform 104 may be determined by the disk 502 used on the handpiece 501. The radius of the thrust platform 104 may be slightly larger than the radius of the disk 502, allowing the disk 502 to spin freely in the thrust platform 104. The half cylinder of the thrust platform 104 may be one-half of the cylinder or it may be slightly larger than one-half. The height of the half cylinder of the thrust platform 104 is sufficient to guard the back of the spinning disk 502. In some embodiments, a partial cover may be added to the top of the cylinder on the thrust platform 104 to further enclose the disk 502. The hole in the bottom of the thrust platform 104 may be large enough to allow the shaft 503 to spin without restriction.

The handpiece 501 could include a rotary motor within a case. A shaft 503 could be connected to one end of the rotary motor and the case and a disk 502 connected to the shaft 503. The disk 502 could be a saw, a diamond blade, a grinder, a bur removal disk, a polishing disk, a brush, a buff wheel, a drill, a stone, a mandrel, a shaped bit, or similar.

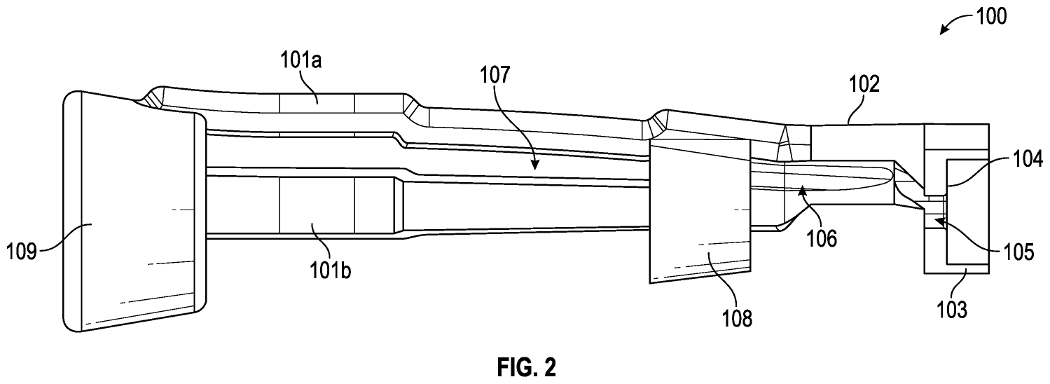

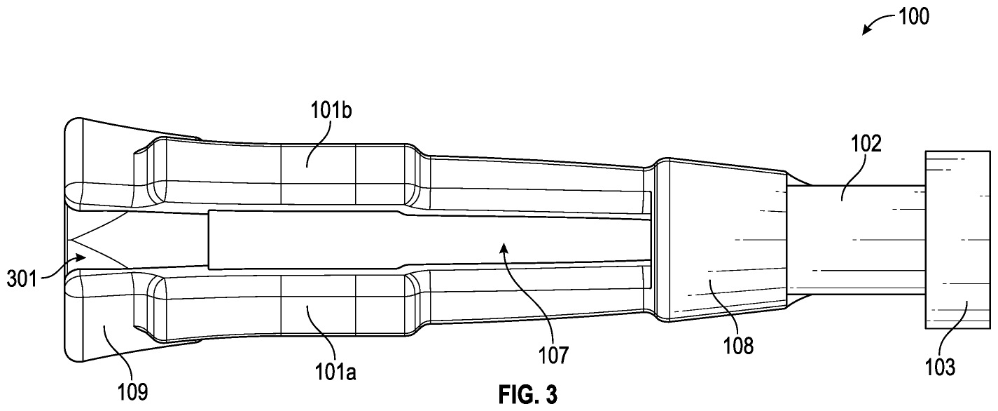

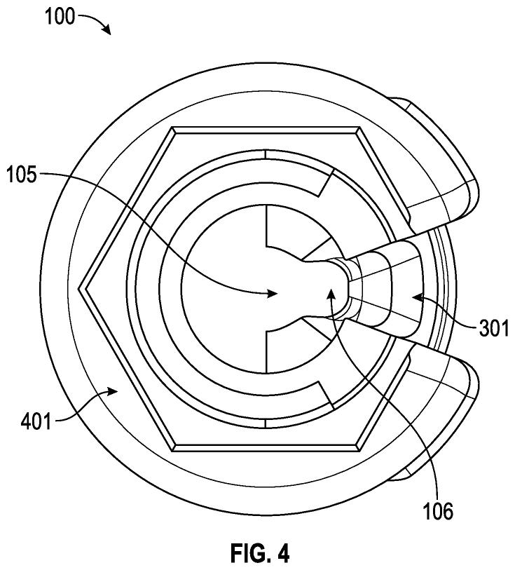

The essence of the protector 100 is illustrated by drawings, where FIG. 1 shows a general view of the protective device 100, FIG. 2 is a side view from the lateral side, and FIG. 3 is another lateral view. FIG. 4 shows a view from the bottom of protector 100 and FIG. 5 shows a protective device assembled with a surgical dental handpiece with a disk and an irrigation tube.

The protector 100 can be made of plastic or photopolymer plastic (ABS similar), and can be produced by Stereolithography photopolymer printing or through press forming. The manufacture of the proposed device 100 from plastic in this embodiment ensures lightweight and disposable use, which significantly increases the ease of use and decreases the cost of production and the price for the end user.

However, other embodiments have other beneficial properties. The protector 100 could be made from plastic, photopolymer plastic (ABS similar), nylon, rubber, silicon rubber, silicon, resin, metal, stainless steel, steel, aluminum, carbon fiber, precious metals, or any combination of the above materials. The protector 100 could be a single piece of material.

In some embodiments, a 3D printer using additive 3D printing, Selective Laser Sintering (SLS), Fused Deposition Modeling (FDM), Digital Light Process (DLP), Multi Jet Fusion (MJF), PolyJet, Direct Metal Laser Sintering (DMLS), or Electron Beam Melting (EBM) could be used. In still other embodiments, injection molding, poured molding, compression molding, polymer casting, or vacuum forming can be used. Alternatively, subtractive technologies such as milling could be used.

The workflow with the surgical protector 100 may be carried out as follows:

The irrigation tube is removed from the surgical dental handpiece 501 used for the operation and connected to the protector 100 by placing the irrigation tube in the channel 105,106. Next, a surgical protector 100 with an irrigation tube is placed on the dental straight handpiece 501, and then disk 502 is installed (See FIG. 5). During the operation, the surgeon presses the pedal of the machine (physiodispensor) that controls the handpiece 501, and the disk 502 is set in motion through the motor and the handpiece 501. At the same time, the surgical protector 100 covers the disk 502 and protects the patient's tissues and the surgeon's fingers from damage.

### Example (Case)

FIG. 6 shows a surgery of bone harvesting that was performed in a clinic. The flow of the procedure: Under local infiltration anesthesia a vestibular trapezoid mucoperiosteal flap 601 was sharply formed and detached from bone surface 602 within a patient's mouth to provide access to the external oblique line on the right side of the lower jaw line with the purpose of harvesting an autogenous bone block. The protector 100 was assembled with straight handpiece 501 and its irrigation tube and a diamond disk 502 6 mm in diameter was fixed in handpiece 501. The irrigation tube is disconnected from the handpiece 501 and the irrigation tube is inserted in the channel 105,106, and then the irrigation tube is reconnected to the handpiece 501. The tip of handpiece 501 with a protector 100 is adapted in the area of the external oblique line. Then surgeon started a motor of handpiece 501 and rotation of disk 502. The disk 502 cut bone 602 but did not damage surrounding soft tissues due to surgical protector 100. The safety and ergonomics of the protector 100, the presence of a good visual overview, and the supply of irrigation solution to the disk 502 are confirmed. At a speed of 35,000 rpm with abundant saline irrigation, distal and mesial vertical bone 602 cuts 10 mm high for a thickness of 3 mm deep were made. The protector 100 fully provides the necessary protection of soft tissues during bone cuts

### Angled Handpiece Protector 700.

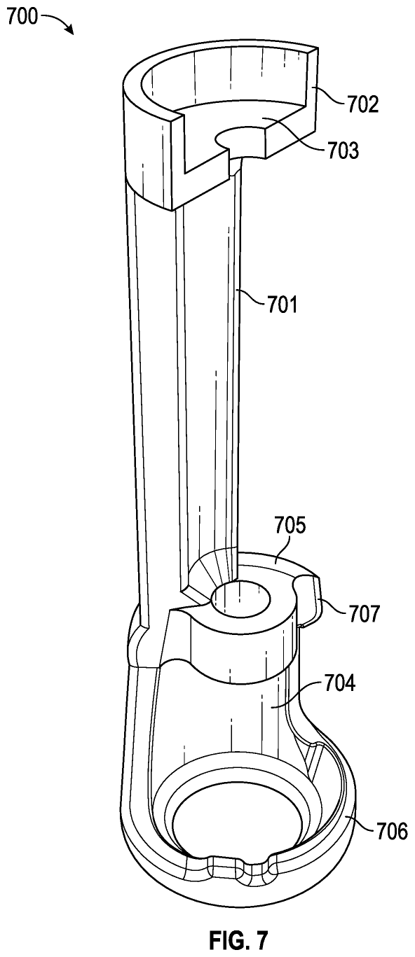

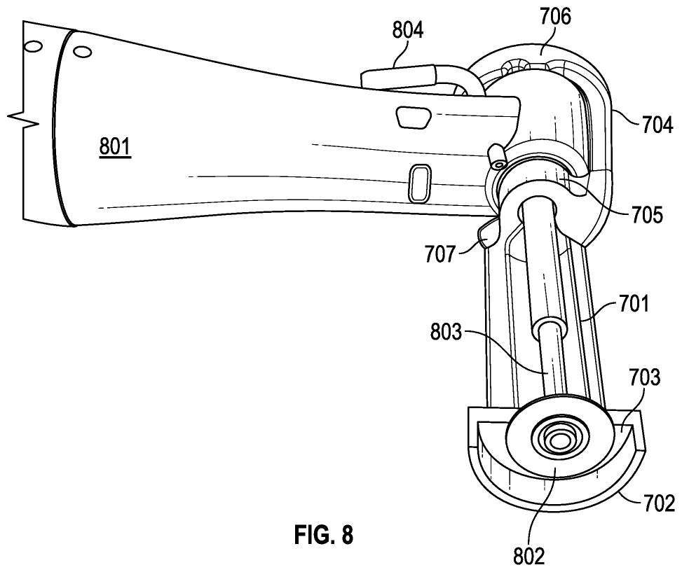

Looking at FIG. 7, the protective device 700 for the angular surgical dental handpiece 801 could contain a body made of a housing wall 701 in the form of a cylinder segment, at one end of which there could be an end semi-ring 702 with a thrust pad 703. At the other end of the body, a base wall 704 could be made for fixing the dental handpiece 801, which may contain small 705 and large 706 rings, which are spaced apart and connected by a base wall 704, which could be a continuation of the housing wall 701. On the small ring 705, a side stop 707 could be made to prevent the rotation of the dental handpiece 801.

The protector 700 can be made of plastic or photopolymer plastic (ABS similar), and can be produced by Stereolithography photopolymer printing or through press forming. The manufacture of the proposed device 700 from plastic in this embodiment ensures lightweight and disposable use, which significantly increases the ease of use and decreases the cost of production and the price for the end user.

However, other embodiments have other beneficial properties. The protector 700 could be made from plastic, photopolymer plastic (ABS similar), nylon, rubber, silicon rubber, silicon, resin, metal, stainless steel, steel, aluminum, carbon fiber, precious metals, or any combination of the above materials.

In some embodiments, additive 3D printing, Selective Laser Sintering (SLS), Fused Deposition Modeling (FDM), Digital Light Process (DLP), Multi Jet Fusion (MJF), PolyJet, Direct Metal Laser Sintering (DMLS), or Electron Beam Melting (EBM) could be used. In still other embodiments, injection molding, poured molding, compression molding, polymer casting, or vacuum forming can be used. Alternatively, subtractive technologies such as milling could be used.

The handpiece 801 could have an irrigation tube 804 and a shaft 803 inserted in the handpiece 801 through a hole in the head of the handpiece 801. The shaft 803 could have a cutting disk 802 at the opposite end of the shaft 803. The disk could be a diamond disk 802 6 mm in diameter.

Work with the protective device 700 may be carried out as follows. The surgical dental handpiece 801 used for the operation, as seen in FIG. 8, is inserted into the base wall 704 of the protective device 700, then a cutter (disk) 802 is installed on the tip through the small ring 705.

During operation, the surgeon presses the pedal of the machine (physiodispensor), and the cutting disk 802 is set in motion through the motor and the tip. At the same time, the protective device 700 covers the cutting disk 802 and protects the patient's soft tissues and the surgeon's fingers from damage.

Numerous alternative forms, equivalents, and modifications will become apparent to those skilled in the art once the above disclosure is fully appreciated. It is intended that the claims be interpreted to embrace all such alternative forms, equivalents, and modifications where applicable.

The above description of the embodiments, alternative embodiments, and specific examples, are given by way of illustration and should not be viewed as limiting. Further, many changes and modifications within the scope of the present embodiments may be made without departing from the spirit thereof, and the present inventions include such changes and modifications.

1. A protective apparatus for a dental device comprising:
a large cone-shaped ring with a gap;
a first longitudinal strip connected to a first side of the gap;
a second longitudinal strip connected to a second side of the gap;
a small cone-shaped ring connected to the first longitudinal strip and to the second longitudinal strip;
a neck connected to the small cone-shaped ring, the neck including an inner channel; and
a thrust platform connected to the neck.

2. The protective apparatus of claim 1 where the neck is a half cylinder.

3. The protective apparatus of claim 1 where the inner channel extends into the small cone-shaped ring.

4. The protective apparatus of claim 1 where the large cone-shaped ring, the first longitudinal strip, the second longitudinal strip, the small cone-shaped ring, the neck, and the thrust platform are plastic.

5. The protective apparatus of claim 4 where the plastic is a single piece.

6. The protective apparatus of claim 5 where the plastic is printed with a 3D printer.

7. The protective apparatus of claim 6 wherein the 3D printer is an SLS photopolymer printer.

8. A protected dental surgery system comprising:
a protective apparatus including:
a large cone-shaped ring with a gap;
a first longitudinal strip connected to a first side of the gap;
a second longitudinal strip connected to a second side of the gap;
a small cone-shaped ring connected to the first longitudinal strip and to the second longitudinal strip;
a neck connected to the small cone-shaped ring, the neck including an inner channel; and
a thrust platform connected to the neck; and
a handpiece including:
a rotary motor;
a case surrounding the rotary motor, the case partially inserted within the large cone-shaped ring, the first longitudinal strip, the second longitudinal strip, and the small cone-shaped ring;
a shaft connected to one end of the rotary motor and the case, the shaft inside of the neck; and
a disk connected to the shaft, the disk above the thrust platform.

9. The protected dental surgery system of claim 8 where the disk is a saw.

10. The protected dental surgery system of claim 8 where the thrust platform includes a raised half cylinder extending above the neck.

11. The protected dental surgery system of claim 10 where the disk is on a plane above the thrust platform and below a top of the raised half cylinder.

12. The protected dental surgery system of claim 8 where the handpiece further includes an irrigation tube connected to the case and located in the inner channel.

13. The protected dental surgery system of claim 12 where the inner channel extends into the small cone-shaped ring and the irrigation tube continues through the inner channel in the small cone-shaped ring.

14. The protected dental surgery system of claim 8 further comprising an angular handpiece protector including:
a cylinder segment housing wall;
a small ring and a large ring, which are spaced apart and connected by a base wall, the small ring connected to the cylinder segment housing wall; and
an end semi-ring with a thrust pad connected to the cylinder segment housing wall.

15. A method of using a protected dental surgery system comprising:
removing a shaft and a disk from a handpiece, the handpiece including a rotary motor, a case surrounding the rotary motor, the shaft connected to one end of the rotary motor and the case, the disk connected to the shaft, and an irrigation tube;
removing the irrigation tube from the handpiece;
inserting the irrigation tube in a channel in a protective apparatus, the protective apparatus including a large cone-shaped ring with a gap, a first longitudinal strip connected to a first side of the gap, a second longitudinal strip connected to a second side of the gap, a small cone-shaped ring connected to the first longitudinal strip and to the second longitudinal strip, a neck connected to the small cone-shaped ring, the neck including an inner channel, and a thrust platform connected to the neck;
inserting the handpiece in the protective apparatus by sliding the one end through the large cone-shaped ring and into the small cone-shaped ring;
reconnect the irrigation tube to the handpiece; and
inserting the shaft and the disk through the thrust platform and into the one end of the rotary motor and the case.

16. The method of using the protected dental surgery system of claim 15 further comprises placing the handpiece and the protective apparatus in a mouth.

17. The method of using the protected dental surgery system of claim 16 further comprises rotating the disk using the rotary motor of the handpiece.

18. The method of using the protected dental surgery system of claim 17 further comprises cutting bone in the mouth with the disk.

19. The method of using the protected dental surgery system of claim 15 wherein the disk is a diamond disk.

20. The method of using the protected dental surgery system of claim 15 further comprises disposing of the protective apparatus after each use.
